(19) United States
(12) Patent Application Publication
(10) Pub. No.: US 2023/0372958 A1
(43) Pub. Date: Nov. 23, 2023

(54) A SPRAY UNIT FOR A REMOTELY OPERABLE SPRAY APPARATUS AND APPARATUS FOR SPRAYING THERMALLY INSULATIVE MATERIAL

(71) Applicant: Q-Bot Limited, London (GB)

(72) Inventors: Chris Hamblin, London (GB); Josh Kiff, London (GB); Daniel Taylor, London (GB); Mathew Holloway, London (GB)

(73) Assignee: Q-Bot Limited, London (GB)

(21) Appl. No.: 17/913,737

(22) PCT Filed: Mar. 22, 2021
(86) PCT No.: PCT/GB2021/050697

§ 371 Date: Sep. 22, 2022

(30) Foreign Application Priority Data
Mar. 25, 2020 (GB) 2004297.4

(51) Int. Cl. B05B 13/00; B05B 7/04; B05B 7/12; B05B 13/04; B05B 15/652; B05B 15/72; B25J 11/00; F15B 13/04; F15B 13/043

(52) U.S. Cl. CPC B05B 13/005; B05B 7/0408; B05B 7/1263; B05B 13/0431; B05B 15/652; B05B 15/72; B25J 11/0075; F15B 13/0402; F15B 13/0431; E04B 1/76

(57) ABSTRACT

There is provided a spray unit for a remotely operable spray apparatus. The spray unit is configured to spray a material having first and second material components. The spray unit comprises a first material inlet for receiving the first material component, a second material inlet for receiving the second material component, and a spray component comprising a mixing chamber and a spray orifice. The spray component is movable between a spraying position in which the mixing chamber is in communication with the first and second material inlets such that the first and second material components enter the mixing chamber and are sprayed via the spray orifice, and a non-spraying position in which the mixing chamber is closed from the first and second material inlets. The spray unit further includes a pneumatic actuator operable to move the spray component between the spraying position and the non-spraying position, and a remotely operable electric actuator arranged to control operation of the pneumatic actuator.

This invention relates to a spray unit for a remotely operated spray apparatus. This invention also relates to aspects of apparatus for spraying thermally insulative material.

### BACKGROUND

To provide underfloor insulation for a suspended floor it is known to remove the suspended floor, position insulation material, and then reassemble the floor.

The applicant's earlier patent applications WO2014188221, WO2016207627, and WO2019043377 provide robotic devices that can be inserted into an underfloor cavity below a suspended floor. The robotic devices carry a spray gun for spraying a thermally insulating material onto the underside of the floor.

### BRIEF SUMMARY OF THE DISCLOSURE

In accordance with the present disclosure there is provided a spray unit for a remotely operable spray apparatus, the spray unit being configured to spray a material having first and second material components; wherein the spray unit comprises:
a first material inlet for receiving the first material component;
a second material inlet for receiving the second material component;
a spray component comprising a mixing chamber and a spray orifice, the spray component being movable between:
a spraying position in which the mixing chamber is in communication with the first and second material inlets such that the first and second material components enter the mixing chamber and are sprayed via the spray orifice; and a non-spraying position in which the mixing chamber is closed from the first and second material inlets;
a pneumatic actuator operable to move the spray component between the spraying position and the non-spraying position; and
a remotely operable electric actuator arranged to control operation of the pneumatic actuator.

Preferably, the spray unit further comprises a pneumatic control mechanism configured to supply compressed air to the pneumatic actuator to control operation of the pneumatic actuator, the pneumatic control mechanism comprising the remotely operable electric actuator.

The pneumatic control mechanism preferably comprises a control component disposed in a control chamber, first and second pneumatic channels connecting the control chamber to opposing sides of the pneumatic actuator; and a compressed air inlet providing compressed air to the control chamber. In this example, the control component is movable between a first position in which the compressed air inlet is in fluid communication with the first pneumatic channel and the compressed air inlet is closed from the second pneumatic channel to move the spray component to the spraying position, and a second position in which the compressed air inlet is in fluid communication with the second pneumatic channel and the compressed air inlet is closed from the first pneumatic channel to move the spray component to the non-spraying position.

The control chamber may further comprise first and second exhaust outlets, and wherein in the first position of the control component the second pneumatic channel is connected to the first exhaust outlet, and in the second position of the control component the first pneumatic channel is connected to the second exhaust outlet.

The position of the control component in the control chamber may be controlled by a pneumatic mechanism. The remotely operable electric actuator may be configured to control the pneumatic mechanism to move the control component between the first position and the second position.

A first end of the control chamber may comprise a first inlet, and a second end of the control chamber may comprise a second inlet. The pneumatic control mechanism may comprise fluid channels that connect the compressed air inlet to the first inlet and the second inlet. The remotely operable electric actuator is preferably operable to open or close at least one of the fluid channels to direct compressed air from the compressed air inlet to the first inlet and/or the second inlet to control movement of the control component between the first position and the second position.

The remotely operable electric actuator preferably comprises a linear actuator, for example a solenoid actuator. The linear actuator is preferably movable between an extended position and a retracted position, and in at least one of the extended position or the retracted position at least one of the fluid channels is blocked.

The remotely operable electric actuator is preferably configured to direct compressed air to either:
the first inlet of the control chamber; or
the first inlet and the second inlet of the control chamber.

In this example, the surface area of the control component at the second end of the control chamber is preferably greater than the surface area of the control component at the first end of the control chamber.

The spray unit may further comprise a spring disposed at the first end of the control chamber and arranged to urge the control component towards the second end of the control chamber.

The spray component, pneumatic actuator, pneumatic control mechanism, and the remotely operable electric actuator are preferably disposed in a housing of the spray unit.

The remotely operable electric actuator is preferably a linear actuator, for example a solenoid actuator, and the direction of movement of the remotely operable electric actuator is preferably offset from the direction of movement of the control component of the pneumatic control mechanism. Accordingly, the spray unit can be compactly arranged in a housing. In some examples, the direction of movement of the remotely operable electric actuator is perpendicular to the direction of movement of the control component of the pneumatic control mechanism. The fluid connections, in particular channels or hoses, provide connections between the different components of the spray unit and therefore permit the remotely operable electric actuator to be located in any orientation relative to the pneumatic control mechanism. One example of a compact arrangement of the remotely operable electric actuator and the pneumatic control mechanism is to arrange them approximately perpendicularly to each other.

The remotely operable electric actuator is preferably configured to be operated from an external control unit. Accordingly, the spray unit can be operated to spray from the external control unit.

The spray component preferably comprises a piston. The piston may form a part of the pneumatic actuator.

The spray unit preferably comprises a single compressed air inlet for receiving a supply of compressed air. A housing of the spray unit preferably comprises a plurality of pneumatic channels arranged to direct the compressed air. Providing a single compressed air inlet provides for fewer connections to the spray unit, allowing the spray unit to be more compact and easier to install/disassemble.

The spray unit may further comprise an air purge opening that is in fluid communication with the mixing chamber and the spray orifice when the spray component is in the non-spraying position. The spray unit may further comprise an air purge channel connecting the compressed air inlet to the air purge opening.

In accordance with a further aspect of the invention, there is provided a robotic device for spraying a thermally insulating material onto an underside of a floor from within an underfloor cavity of a building. The robotic device is preferably controlled from an external control unit outside of the underfloor cavity. The robotic device preferably includes the spray unit described above, controllable from the external control unit. The spray unit is particularly adapted for such a use as it is compact and can be remotely operated to spray the thermally insulating material.

In other examples, the spray unit can be used in a manufacturing process, for example by a robotic manipulator or a CNC machine. Most existing spray apparatus is primarily designed to be used by hand and therefore is constrained physically to suit a human operator and manually controlled. The spray unit of the invention is light and compact and can be autonomously controlled for use on a machine tool or robotic device in a range of different manufacturing applications.

In particular, in accordance with a further aspect of the invention there is provided a robotic device for spraying a thermally insulating material onto a surface of a building element, for example a wall or a façade. The robotic device includes the spray unit described above. In some examples, the robotic device is configured to be operated in an off-site location, for example a factory, for manufacturing a building element that is later mounted to a building or assembled to form a building. In other examples, the robotic device is configured to be deployed and operated on-site to apply a thermally insulating material to a building element, such as a wall or façade. In some examples the robotic device may comprise an articulated arm on which the spray unit is mounted. In other examples the robotic device comprises a frame or gantry having a movable part to which the spray unit is attached. The robotic device may be operable to move the spray unit over a surface of a building element to apply a layer of thermally insulating material thereto.

In accordance with a further aspect of the invention, there is provided a robotic device for spraying a thermally insulating material onto an underside of a floor from within an underfloor cavity of a building, the robotic device comprising:
a chassis;
a rotatable housing mounted to the chassis for rotation about a housing axis;
a spray unit mounted to the rotatable housing, the spray unit being configured to spray the thermally insulating material in a spraying direction;
a sensor mounted to the rotatable housing, the sensor being directed in a sensing direction;
wherein the spray unit and the sensor are mounted to the rotatable housing so that the spraying direction is offset from the sensing direction in the direction of rotation of the rotatable housing.

The spray unit is preferably configured to spray the thermally insulating material while the rotatable housing rotates to vary the spraying direction.

The spray unit is preferably rotatably mounted to the rotatable housing about a spray unit axis, the spray unit axis being perpendicular to the housing axis. The robotic device may further comprise an actuator arranged to rotate the spray unit about the spray unit axis. The spray unit is preferably configured to be rotated about the spray unit axis of rotation during spraying of the thermally insulating material to vary the spraying direction.

The sensor preferably comprises a depth sensor. For example, the depth sensor may be a stereo infrared depth camera. Alternatively or additionally, the sensor may comprise a rangefinder sensor, for example a laser rangefinder sensor, a camera, and/or a thermally imaging sensor. In some examples, the sensor comprises a solid state Lidar sensor.

The spray unit is preferably detachable from the rotatable housing.

In accordance with a further aspect of the invention, there is provided a robotic device for operating in an underfloor cavity below a floor of a building, the robotic device comprising a sensor assembly having a housing and at least one sensor mounted to the housing; wherein the housing is movable between an extended position in which the sensor assembly protrudes from robotic device, and a retracted position in which the sensor assembly does not protrude from the robotic device; and wherein the at least one sensor of the sensor assembly is arranged such that in both the extended position and the retracted position the sensor has a field of view encompassing a part of the underfloor cavity, in particular a part of an underside of the floor.

Preferably, in the retracted position the sensor assembly is housed within the robotic device and does not protrude further than any other component of the robotic device.

The robotic device preferably comprises a pneumatic actuator configured to move the housing between the extended position and the retracted position. The pneumatic actuator is preferably controlled from an external control unit located outside of the underfloor cavity.

Preferably, the sensor has a sensing direction that is angled with respect to a direction of movement of robotic device. The angled arrangement provides for the field of view of the sensor to encompass a part of the underfloor cavity in the retracted position. In particular, the sensor is orientated to look forwards and upwards at an angle relative to the robotic device when the robotic device is on a ground surface of the underfloor cavity. In preferred examples, the sensor, or an additional sensor, is angled such that a field of view of the sensor encompasses a part of the floor or ground in front of the robotic device. Preferably, the sensor has a field of view that encompasses a part of the ground in front of the robotic device and at the same position a part of the underfloor cavity to be sprayed, preferably an underside surface of the floor. In this way, the sensor can be used to detect the surface to be sprayed and can also be used to identify obstacles in the underfloor cavity.

In preferred examples, the robotic device comprises a plurality of wheels arranged to support the robotic device on a ground surface, and wherein the sensor is arranged such that the sensing direction is angled away from the ground surface during use. In this way, the sensor can view the underside of the floor from the within the underfloor cavity.

Preferably the robotic device comprises a second sensor disposed in a different orientation in the housing. For example, the sensor may be directed in a forward direction of the robotic device, and the second sensor may be directed in a rearward direction of the robotic device. The second sensor may be directed at an angle relative to the ground surface to look rearwards and upwards from the robotic device.

Preferably, the robotic device further comprises a motor and a pulley-belt assembly configured to couple the rotatable housing to the motor such that the motor is operable to rotate the rotatable housing. In this example, a connection for the spray unit and/or the sensor, for example a pneumatic or electrical connection, may be routed from the chassis to the rotatable housing through an opening in the pulley. Preferably the opening in the pulley is aligned with the housing axis. In this way, the connection is routed internally of the robotic device and is protected from the environment in which the robotic device is operating. Additionally, routing the connection in this way means that the connection is not twisted when the rotatable housing is rotated.

Additionally, the robotic device, in particular the rotatable housing, may further comprise a motor and pulley-belt assembly configured to couple the motor to the spray unit such that the motor is operable to rotate the spray unit relative to the rotatable housing. In this example, a connection for the spray unit, for example a pneumatic or electrical connection, may be routed from the rotatable housing to the spray unit through an opening in the pulley mounted to the spray unit, where the opening is preferably aligned with a rotational axis of the spray unit. In this way, the connection is routed internally of the rotatable housing and is protected from the environment in which the robotic device is operating. Additionally, routing the connection in this way means that the connection is not twisted when the spray unit is rotated.

In accordance with a further aspect of the invention, there is provided a sensor unit comprising a housing, a sensor mounted in the housing and directed in a sensing direction, and a protective film assembly arranged to protect the sensor from debris; wherein the protective film assembly comprises a spool mount for a spool of transparent film, a winding mount comprising a winding spool and an actuator arranged to wind the transparent film onto the winding spool, and a guide arranged to guide the transparent film past the sensor such that the transparent film is disposed in the sensing direction of the sensor; and wherein the spool mount and the winding mount are removable from the protective film assembly for replacing the spool of transparent film. Preferably, the spool mount and the winding mount constitute a removable assembly. Preferably, the removable assembly includes a part of the housing and the spool mount and the winding mount are attached to the part of the housing, so that the part of the housing, the spool mount, and the winding mount (i.e. the removable assembly) can be removed from the sensor unit for replacing the spool of transparent film.

Preferably, the sensor unit further comprises a drive coupling arranged to couple the actuator to the winding spool. A part of the drive coupling remains attached to the winding spool on removal of the winding mount from the sensor unit. In particular, the actuator may comprise a motor and the drive coupling may comprise at least two gears arranged to rotationally couple the motor to the winding spool. The removable assembly preferably comprises at least one of the gears. On removal of the removable assembly from the sensor unit the gears can disengage, and the gears can be re-engaged on replacement of the removable assembly on the sensor unit.

### BRIEF DESCRIPTION OF THE DRAWINGS

Embodiments of the invention are further described hereinafter with reference to the accompanying drawings, in which:

FIG. 1 shows a perspective view of a robotic device for operating in a confined space under a floor of a building;

FIG. 2 shows a top view of the robotic device of FIG. 1;

FIG. 3 shows a side view of the robotic device of FIGS. 1 and 2;

FIG. 4 shows the robotic device of FIGS. 1 to 3 in an underfloor cavity;

FIGS. 5A and 5B show the spray unit of the robotic device of FIGS. 1 to 4;

FIGS. 6A and 6B show cross-sections of the spray unit of FIGS. 5A and 5B;

FIGS. 7A and 7B are schematic diagrams of a pneumatic control system of the spray unit of FIGS. 5A to 6B;

FIGS. 8 to 10 show a front of the robotic device of FIGS. 1 to 4, including the spray unit of FIGS. 5A to 7B, and a rotatable housing;

FIGS. 11 to 13 show different views of the rotatable housing;

FIGS. 14A and 14B show a camera assembly of the robotic device of FIGS. 1 to 4;

FIG. 15 shows the camera assembly of FIGS. 14A and 14B in a retracted position;

FIG. 16 shows the camera assembly of FIGS. 14A and 14B in isolation;

FIG. 17 shows a partial side view of the camera assembly of FIGS. 14A and 14B, illustrating a removable cartridge;

FIGS. 18A and 18B show the removable cartridge of the camera assembly of FIGS. 14A and 14B; and

FIGS. 19A and 19B show example robotic devices including the spray unit of FIGS. 5A to 7B.

### DETAILED DESCRIPTION

The present invention relates to apparatus for spraying thermally insulating material. In particular, the present invention relates to a spray unit for remotely operable spray apparatus. The present invention also relates to a robotic device for spraying a thermally insulating material in a confined space, for example in an underfloor cavity of a building, and to aspects of the robotic device, in particular a sensor unit.

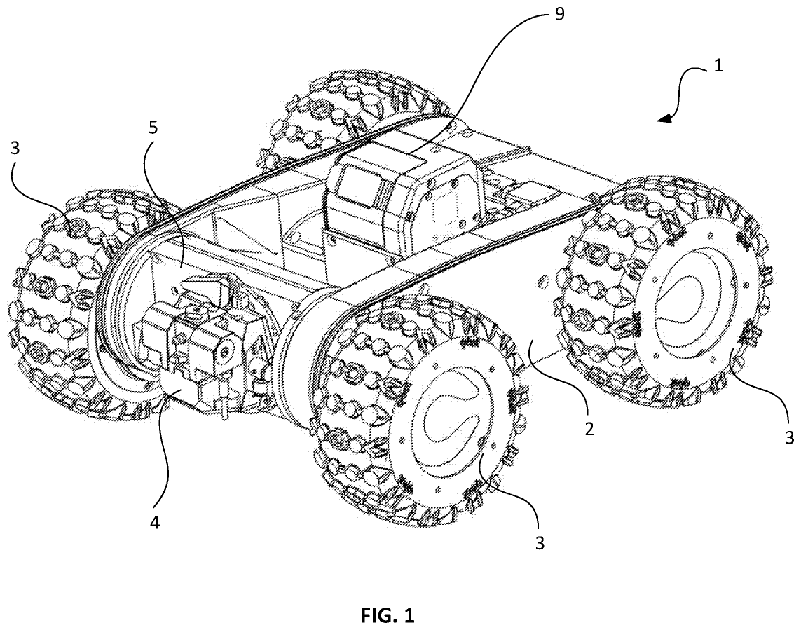

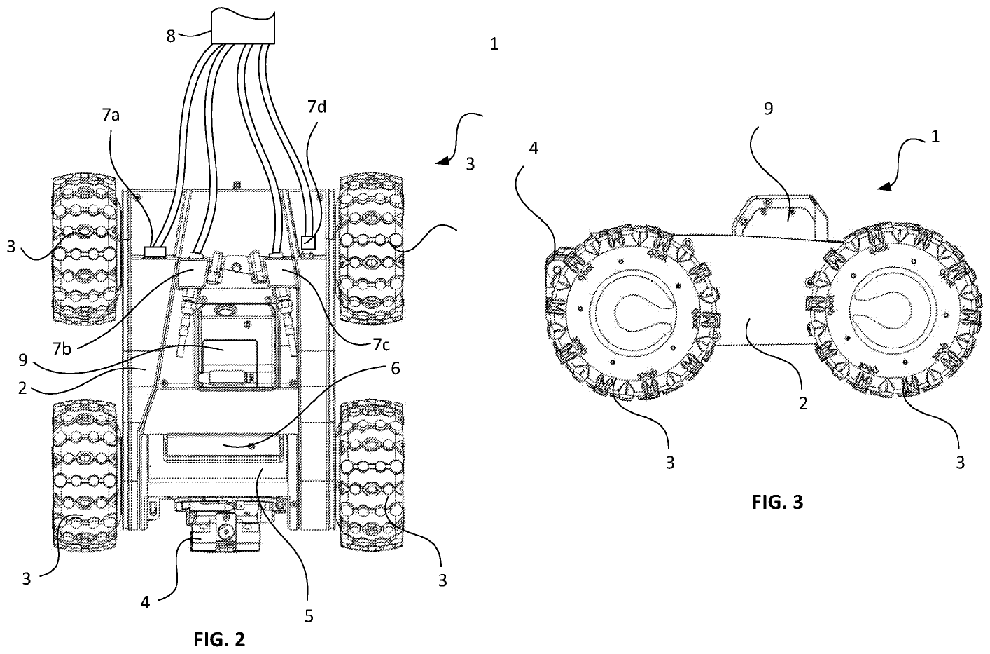

As shown in FIGS. 1 to 3, the robotic device 1 includes a chassis 2 and wheels 3, in this example four wheels 3. At least some of the wheels 3 are driven wheels 3, having an electric motor incorporated into the wheel 3 and being individually controllable so that the robotic device 1 can be driven and turned or rotated. Preferably, all of the wheels 3 are driven wheels 3. Preferably, the wheels 3 are detachable from the chassis 2.

The robotic device 1 includes a port 7, in this example a plurality of ports 7a, 7b, 7c, 7d, that are connectable to a hose 8. The ports 7 include an electronic port 7a for connection to an external control unit. The ports 7 also include first and second insulation material ports 7b, 7c for connection to sources of first and second insulation materials, as described in further detail hereinafter. The ports 7 also include a compressed air port 7d for connection to a source of compressed air. Each of the connections is provided via the hose 8. The robotic device 1 receives power and control signals via the hose 8 and the electronic port 7a. The hose 8 also connects the robotic device 1 to a source of thermally insulating material located outside of the underfloor cavity via the first and second insulation material ports 7c, 7d. The hose 8 also provides a supply of compressed air via compressed air port 7d. In this way, the robotic device 1, in particular the wheels 3, are remotely controllable and the robotic device 1 does not need to carry the source of thermally insulating material or an air compressor.

In preferred examples, the robotic device 1 comprises a spray unit 4 for spraying the thermally insulating material. In preferred examples, the thermally insulating material is a thermally insulating foam, for example polyurethane foam. The polyurethane foam may be provided to the robotic device 1 by the hose 8 in two parts in separate tubes within the hose. In particular, the two parts of sprayable polyurethane foam are an isocyanate and a polyol. These two parts of the polyurethane foam are mixed in the spray unit 4 and are sprayed together at the surface to be insulated, and they react to create an insulative covering on the surface. The hose 8 may include heating elements to heat the two parts of the polyurethane foam.

In other examples, the robotic device 1, in particular the spray unit 4, may spray other thermally insulating materials, such as other sprayable foams, or a mineral wool material, or a fibreglass material, or a polystyrene material, or a cellulose insulation material.

As described further hereinafter, the spray unit 4 includes a solenoid actuator that is remotely controllable. Therefore, operation of the spray unit 4 can be controlled from the external control unit.

As shown in FIGS. 1 to 3, the spray unit 4 is mounted at a front of the robotic device 1 on a rotatable housing 5. The spray unit 4 is preferably detachable from the rotatable housing 5. A sensor is mounted to the rotatable housing 5, on an opposite side to the spray unit 4. The sensor is preferably a depth camera 6, for example a stereo infrared camera, for example an Intel® D435 depth camera. Alternatively, the sensor may be a rangefinder sensor, particularly a laser rangefinder sensor, a thermal imaging sensor, a video camera, or any combination of these. In some examples, the sensor is a solid state Lidar sensor.

As explained in more detail hereinafter, the rotatable housing 5 can rotate to move the spray unit 5 and the depth camera 6 between different operational positions, for spraying thermally insulating material using the spray unit 4 and/or detecting a position of a surface and/or features of the underfloor cavity using the depth camera 6. For example, the depth camera 6 may be used to detect the surface to which insulation material is being applied to determine the position of the surface. The depth camera 6 may also be used to detect a depth of insulation applied to the surface by detecting the position of the surface before and after application of insulation material. The depth camera 6 may additionally or alternatively be used to detect the position of an obstacle in the underfloor cavity, or an end of the underfloor cavity.

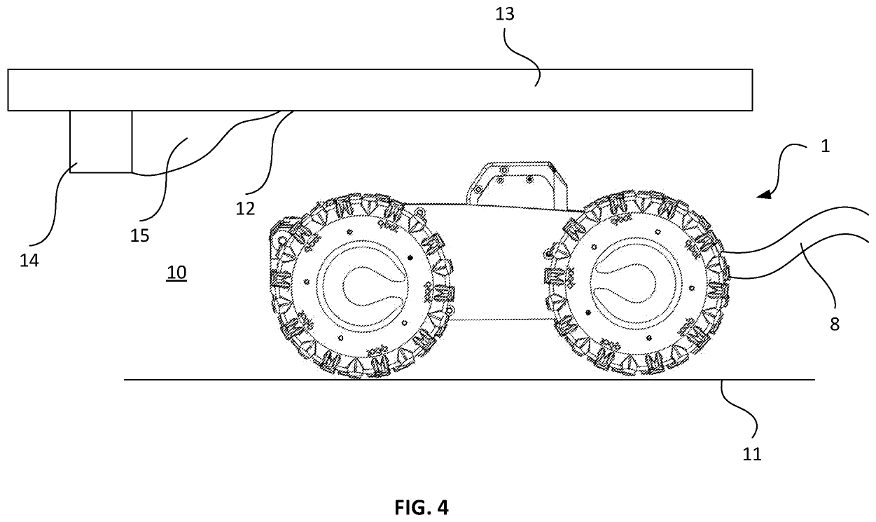

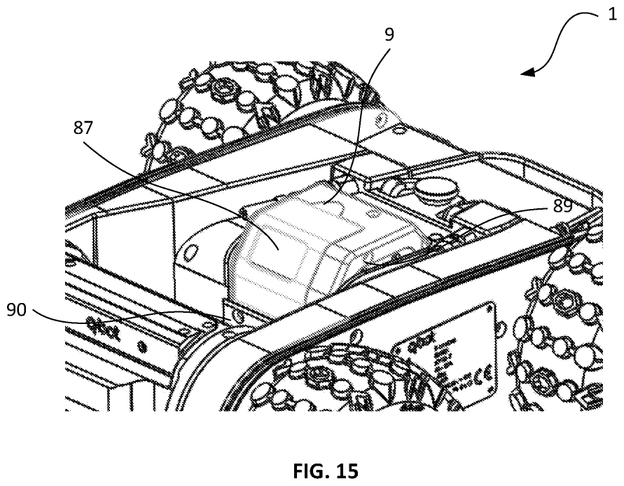

The robotic device also includes a camera assembly 9. As described in further detail hereinafter, the camera assembly 9 comprises a forward-facing camera. The forward facing camera 87 is angled so that it is directed towards the surface to be sprayed during use, as described with reference to FIG. 4. In some examples, the camera assembly 9 further includes a rearward-facing camera. The rearward-facing camera is also preferably angled towards the surface to be sprayed during operation. The camera assembly 9 is movable between a protruding position, shown in FIGS. 1 to 4, 14A and 14B, and a retracted position, shown in FIG. 15. The robotic device 1 preferably includes a light source to illuminate the surroundings for the camera assembly 9.

FIG. 4 shows the robotic device 1 when deployed in an underfloor cavity 10. The underfloor cavity 10 is formed between a ground surface 11 and an underside 12 of a floor 13. The floor 13 is a suspended floor. The suspended floor 13 may be mounted on beams 14, or the suspended floor 13 may be a flat surface such as a concrete slab. The floor 13 and other parts, for example the beams 14, may be made of various materials such as wood, metal, stone, or concrete. The robotic device 1 is sized so as to fit in the underfloor cavity 10 and can spray thermally insulating material 15 onto the underside 12 of the floor 13 to provide an insulative covering.

The robotic device 1 may be inserted into the underfloor cavity 10 through an access port in the floor, or through an access port in a wall. An access port in the wall may be formed by removing one or more bricks from the wall. The hose 8 is connected to the robotic device 1 and extends outside of the underfloor cavity 10 through the access port. As described earlier, the hose 8 is connected to an external control unit, an external source of thermally insulating material, and an external source of compressed air.

The wheels 3 are controllable from the external control unit to drive the robotic device 1 over the ground 11 to move into different positions for spraying the underside 12 of the floor 13. The camera assembly 9 provides a video feed to the external control unit so that the operator can see the underfloor cavity 10. The spray unit 4 is supplied with the thermally insulating material via the hose 8 and sprays the underside 12 of the floor 13 to provide an insulative covering 15. The depth camera 6 may be used to detect the position of the underside 12 of the floor 13 to be sprayed, to identify obstacles, for example the joist 14, and/or to detect the insulative covering 15 after spraying, for example to determine a depth of the insulative covering 15.

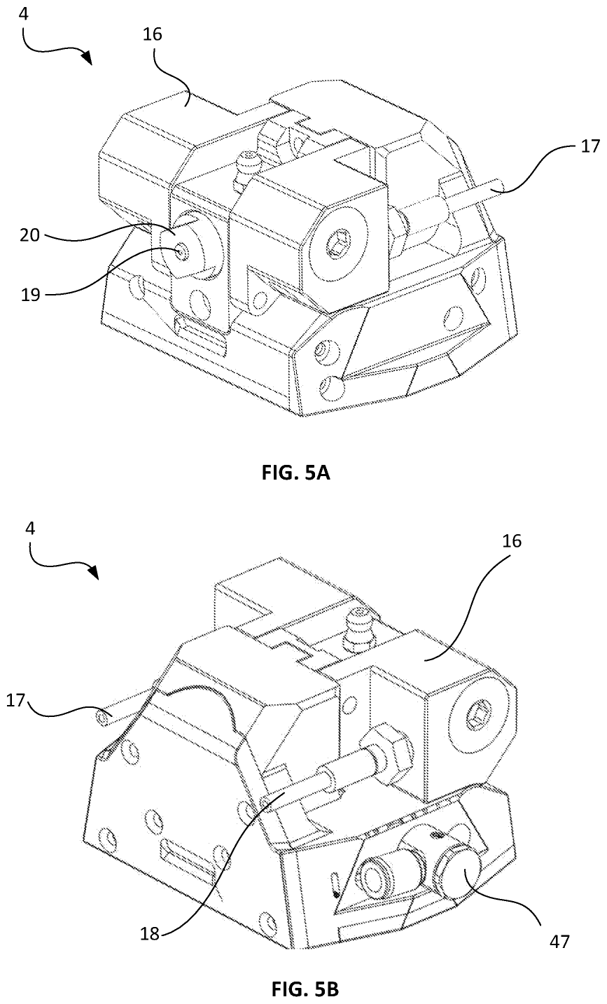

FIGS. 5A to 7B illustrate the spray unit 4 of the robotic device 1. As described hereinafter, the spray unit 4 is remotely operable so that an operator can operate the spray unit 4 from the external control unit located outside of the underfloor cavity 10 illustrated in FIG. 4. In particular, the operator can control the spray unit 4 to spray insulation material. As will become apparent hereinafter, the spray unit 4 is compact and requires few connections to operate, making it simple to remove from the robotic device 1 and compact for operation in the underfloor cavity 10.

As shown in FIGS. 5A and 5B, the spray unit 4 includes a housing 16. The spray unit 4 also includes a first material input port 17 for connection to a source of a first material via the hose 8 illustrated in FIG. 4, and a second material input port 18 for connection to a source of a second material via the hose 8 illustrated in FIG. 4. The first and second materials are component materials of the thermally insulating material sprayed by the spray unit 4. In a preferred example, the first material is an isocyanate and the second material is a polyol, and on mixing and spraying the first and second materials combine to form a polyurethane foam.

The first and second materials are supplied to the first and second material input ports 17, 18 under pressure. The pressure for polyurethane insulation may be between about 500 psi and about 1,500 psi (between about 3,500 kPa to about 10,500 kPa).

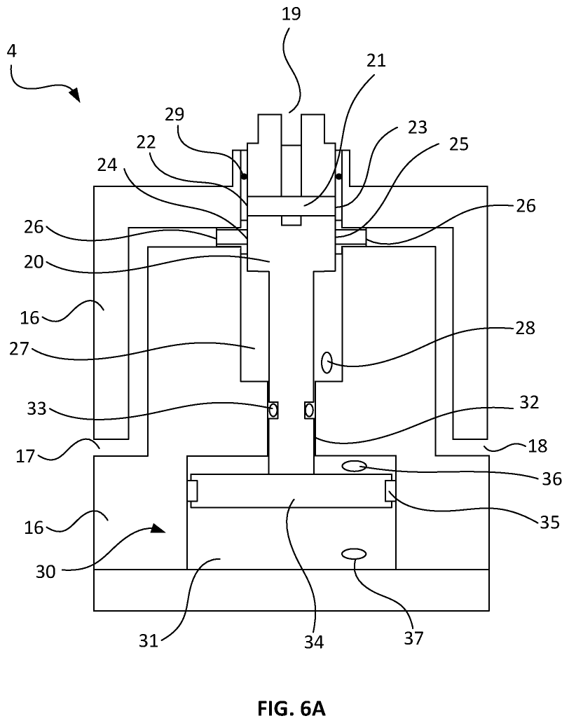

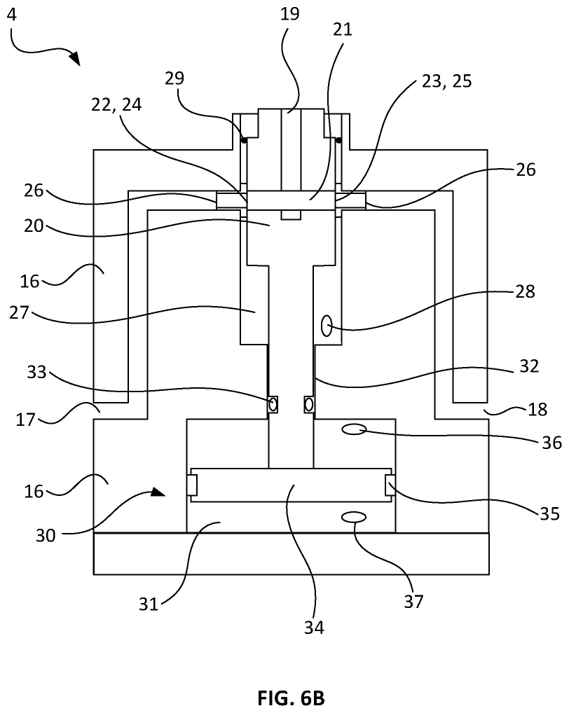

Referring to FIGS. 5A, 6A and 6B, the spray unit 4 includes a spray component 20 that defines a spray orifice 19 from which the mixed first and second materials are sprayed during operation. As described further hereinafter, the spray component 20 is movable between a non-spraying position, shown in FIG. 6A, in which no material is sprayed from the spray orifice 19, and a spraying position, shown in FIG. 6B, in which material is sprayed from the spray orifice 19.

FIGS. 6A and 6B show a schematic cross-section through the spray unit 4, in particular through the housing 16, the first material input port 17, the second material input port 18, and the spray component 20 defining the spray orifice 19.

The spray component 20 is preferably generally cylindrical and received in a corresponding chamber 27 formed in the housing 16.

As illustrated in FIGS. 6A and 6B, the spray component 20 comprises a mixing chamber 21 having a first opening 22 and a second opening 23. The mixing chamber 21 is connected to the spray orifice 19. As also illustrated, the first and second material input ports 17, 18 both extend through the housing 16 to respective outlets 24, 25 into the chamber 27, are adjacent to the spray component 20.

As shown in FIG. 6A, when the spray component 20 is in the non-spraying position the first opening 22 and the second opening 23 in the spray component 20 are not aligned with the outlets 24, 25 of the first and second material input ports 17, 18. Therefore, the first and second materials do not enter the mixing chamber 21 and are not sprayed via the spray orifice 19. In the non-spraying position illustrated in FIG. 6A, the outlets 24, 25 of the first and second material input ports 17, 18 are closed by a side of the spray component 20. As illustrated, seals 26 may be provided at the outlets 24, 25 to ensure that the side of the spray component 20 seals the outlets 24, 25 in the chamber 27 in the non-spraying position. As will be appreciated, the seals 26 are only provided at the outlets 24, 25 and do not extend around the circumference of the chamber 27 at that location. This leaves a fluid path within the chamber 27, around the seals 26, that is not shown in the cross-section of FIGS. 6A and 6B.

As shown in FIG. 6B, in the spraying position the spray component 20 is positioned such that the first opening 22 and the second opening 23 are aligned with the outlets 24, 25 of the first and second material input ports 17, 18, respectively. In this position, the first and second materials enter the mixing chamber 21 and are sprayed via the spray orifice 19.

As illustrated in FIG. 5B, the spray unit 4 may additionally include a compressed air input 47. From the compressed air input port 47 a supply of compressed air may be provided to purge inlet 28 in the chamber 27 shown in FIGS. 6A and 6B. In the non-spraying position, as shown in FIG. 6A, the first opening 22 and the second opening 23 in the spray component 20 are open to the chamber 27, so compressed air would pass into the mixing chamber 21 and push any residual material out of the spray orifice 19, thereby purging the spray unit 4 and preventing blockages. Seal 29 may be provided between the chamber 27 and the spray component 20 to prevent purge air from escaping from the chamber 27 except via the mixing chamber 21 in the spraying component 20 in the non-spraying position.

As shown in FIGS. 6A and 6B, a pneumatic actuator 30 is provided to move the spray component 20 between the spraying and non-spraying positions illustrated. In particular, in the illustrated example the housing 16 defines an actuator chamber 31 that is separate to the chamber 27. Spray component 20 extends from the chamber 27 into actuator chamber 31 via passage 32. A seal 33 is provided to seal the chamber 27 from the actuator chamber 31.

A part of the spray component 20 in the actuator chamber 31 comprises a piston 34. The piston 34 preferably includes a seal, in particular an O-ring 35, that seals the piston 34 against the surface of the actuator chamber 31. In this way, the piston 34 and actuator chamber 31 form a pneumatic actuator 30 for moving the spray component 20 between the positions illustrated in FIGS. 6A and 6B.

The actuator chamber 31 includes two ports 36, 37 arranged in the actuator chamber 31 on opposite sides of the piston 34. As explained further hereinafter, a pneumatic control mechanism selectively supplies compressed air to one of the ports 36, 37 and opens the other to exhaust in order to move the piston 34 and the spray component 20 between the positions illustrated in FIGS. 6A and 6B.

That is, the spray unit 4 includes a pneumatic actuator 30 configured to move the spray component 20 between the spraying position and the non-spraying position. The pneumatic actuator is controlled by a pneumatic control mechanism. As explained hereinafter, operation of the pneumatic control mechanism is controlled by a remotely operated electric actuator.

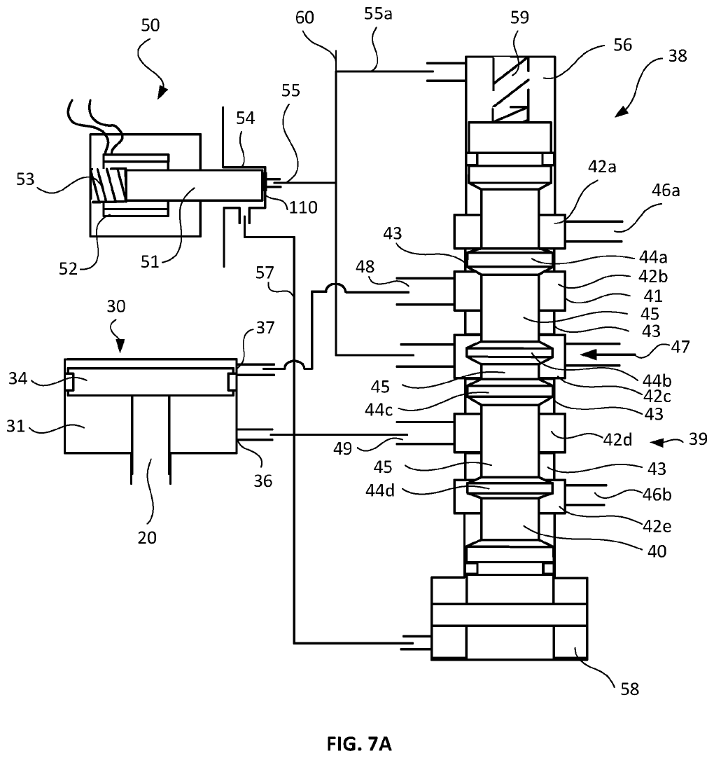

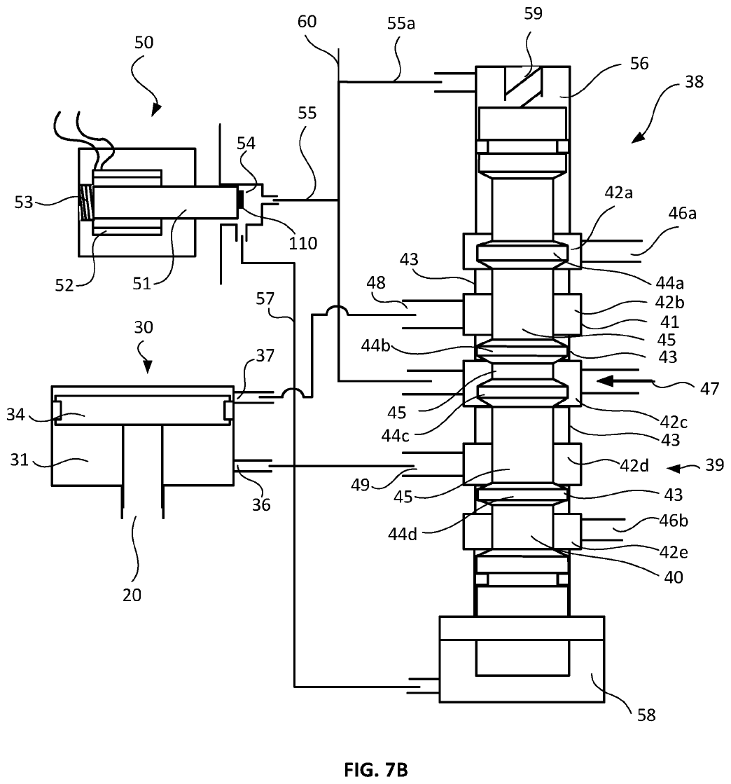

FIGS. 7A and 7B show schematic diagrams of the pneumatic actuator 30 and the pneumatic control mechanism 38. As shown in FIGS. 7A and 7B, the pneumatic control mechanism 38 includes a pneumatic routing assembly 39 having a control component 40 that moves within a control chamber 41. The control chamber 41 is substantially cylindrical, and the control component 40 is a shaft that can slide in the control chamber 41 as described hereinafter. The control chamber 41 has a plurality of sub-chambers 42a, 42b, 42c, 42d, 42e separated by narrow sections 43. The control component 40 has a plurality of sealing portions 44a, 44b, 44c, 44d separated by narrow shaft sections 45.

Sub-chambers 42a and 42e each comprise an exhaust outlet 46a, 46b to outside of the spray unit 4. Sub-chamber 42c comprises an air inlet 47 for receiving a supply of compressed air. Air inlet 47 is connected to compressed air input port 47 shown in FIG. 5B. Sub-chamber 42b is connected to port 36 of the pneumatic actuator 30 via a fluid connection 48. Sub-chamber 42d is connected to port 37 of the pneumatic actuator 30 via fluid connection 49.

As illustrated in FIG. 7A, when the control component 40 is in a first position, in this illustration at a lower end of the control chamber 41, air inlet 47 is fluidly connected to the port 37 of the pneumatic actuator 30 via sub-chambers 42c, 42b, and fluid connection 48. Also, port 36 of the pneumatic actuator 30 is fluidly connected to exhaust outlet 46b via fluid connection 49 and sub-chambers 42d, 42e. Therefore, in this position compressed air urges the piston 34 of the pneumatic actuator 30, and the spray component 20, into a non-spraying position as described with reference to FIG. 6A.

As illustrated in FIG. 7B, when the control component 40 is in a second position, in this illustration at an upper end of the control chamber 41, air inlet 47 is fluidly connected to the port 36 of the pneumatic actuator 30 via sub-chambers 42c and 42d, and fluid connection 49. Also, port 37 of the pneumatic actuator 30 is fluidly connected to exhaust outlet 46a via fluid connection 48 and sub-chambers 42a and 42b. Therefore, in this position compressed air urges the piston 34 of the pneumatic actuator 30, and the spray component 20, into a spraying position as described with reference to FIG. 6B.

In this way, the position of the control component 40 within the control chamber 41 controls the flow of compressed air to the pneumatic actuator 30 and therefore controls whether the spray unit 4 sprays material, or not.

As also illustrated in FIGS. 7A and 7B, an electric actuator, in particular a solenoid actuator 50, is configured to control the position of the control component 40 within the control chamber 41.

The solenoid actuator 50 has a solenoid shaft 51, a coil 52, and a spring 53 arranged to urge the solenoid shaft 51 to an extended position as shown in FIG. 7A. In FIG. 7A the coil 52 is not activated (i.e. there is no current passing through the coil 52), so the solenoid shaft 51 is in the extended position due to the spring 53.

The solenoid shaft 51 extends into a chamber 54. The chamber 54 has a first fluid connection 55 to sub-chamber 42c of the routing chamber 41. Sub-chamber 42c of the routing chamber 41 has the air inlet 47, so the first fluid connection 55 is always provided with compressed air. The first fluid connection 55 has a branch fluid connection 55a to a first end 56 of the control chamber 41. The chamber 54 has a second fluid connection 57 to a second end 58 of the control chamber 41. The first end 56 of the control chamber 41 has a smaller cross-sectional area than the second end 58 of the control chamber 41. A spring 59 is provided at the first end 56 of the control chamber 41 to urge the control component 40 towards the second end 58. A seal 110 is provided on the solenoid shaft 51 and the adapted to seal the first fluid connection 55 when the solenoid shaft 51 is in the position shown in FIG. 7A. As shown in FIG. 7A, in the non-activated position the seal 110 acts to seal the first fluid connection 55 from the second fluid connection 57.

In the position shown in FIG. 7A, the solenoid shaft 51, in the extended position because the coil 52 is not activated, blocks the first and second fluid connections 55, 57. Therefore, compressed air is supplied to the first end 56 of the control chamber 41 and not to the second end 58 of the control chamber 41. Therefore, the compressed air, together with the spring 59, urges the control component 40 towards the second end 58 of the control chamber 41 and into the first position, as illustrated. As explained previously, the spray unit 4 does not spray material in this configuration.

As illustrated in FIG. 7B, when the coil 52 is activated the solenoid shaft 51 moves to a retracted position which opens a fluid path between fluid connections 55 and 57. The seal 110 no longer acts to seal the first fluid connection 55 from the second fluid connection 57, so compressed air is provided to both the first end 56 and the second end 58 of the control chamber 41. As the second end 58 has a greater cross-sectional area than the first end 56 the net effect of the compressed air is to move the control component 40 to the second position as illustrated. In this position an opposite end of the solenoid shaft 51 may act to seal an outlet of the chamber 54 to prevent venting of the compressed air.

As explained previously, the spray unit 4 is caused to spray material in this configuration.

When the solenoid actuator 50 is then deactivated again (i.e., when the shaft 51 moves from the position shown in FIG. 7B to the position shown in FIG. 7A) the air from the second end 58 can escape through the second fluid connection 57 and into the chamber 54 to vent. Accordingly, the control component 40 can move towards the second end 58 and the spray unit 4 is stopped from spraying.

Branch fluid connection 60 may be provided to supply compressed air to the air purge inlet 28 illustrated in FIGS. 6A and 6B.

The fluid connections 48, 49, 55, 55a, 57, 59, 60 are provided by channels formed within a part of the spray unit 4. Preferably, the channels are formed in a housing of the spray unit 4, but the channels may alternatively be provided by separate hoses or pipes.

Therefore, the pneumatic control mechanism 38 is controlled by the solenoid actuator 50. The solenoid actuator 50 is controlled by either providing power to the coil 52 or not providing power to the coil 52 to move the solenoid shaft 51 and alter the fluid connections in the pneumatic control mechanism 38. Accordingly, the pneumatic control mechanism 38 and solenoid actuator 50 together provide for remotely operating the spray unit 4.

Referring to FIGS. 5A, 5B, 7A, and 7B, the pneumatic control mechanism 38 and the solenoid actuator 50 are arranged within the housing 16 of the spray unit 4. In particular, the housing 16 includes a base portion, and a spray portion. The spray component 20 and the pneumatic actuator 30 are arranged in the spray portion, and the pneumatic control mechanism 38 and solenoid actuator 50 are arranged in the base portion. In the illustrated example the axis of movement of the solenoid shaft 51 is perpendicular to the axis of movement of the control component 40 and the axial direction of the control chamber 41. The pneumatic connections between the pneumatic control mechanism 38, the solenoid actuator 50, and the pneumatic actuator 30 allow these elements of the spray unit 4 to be arranged in different positions. In this way, the spray unit 4 is compact and more easily mounted to the robotic device 1.

In addition, the spray unit 4 has only a single compressed air input port 47 from which the compressed air is directed, as described previously, for moving the control component 40 according to the position of the solenoid shaft 51, for moving the pneumatic actuator 30 and spray component 20 according to the position of the control component 40, and for the air purge inlet 28. Providing only a single compressed air input port 47 makes the spray unit 4 more compact and easier to disconnect from the robotic device 1 for removal.

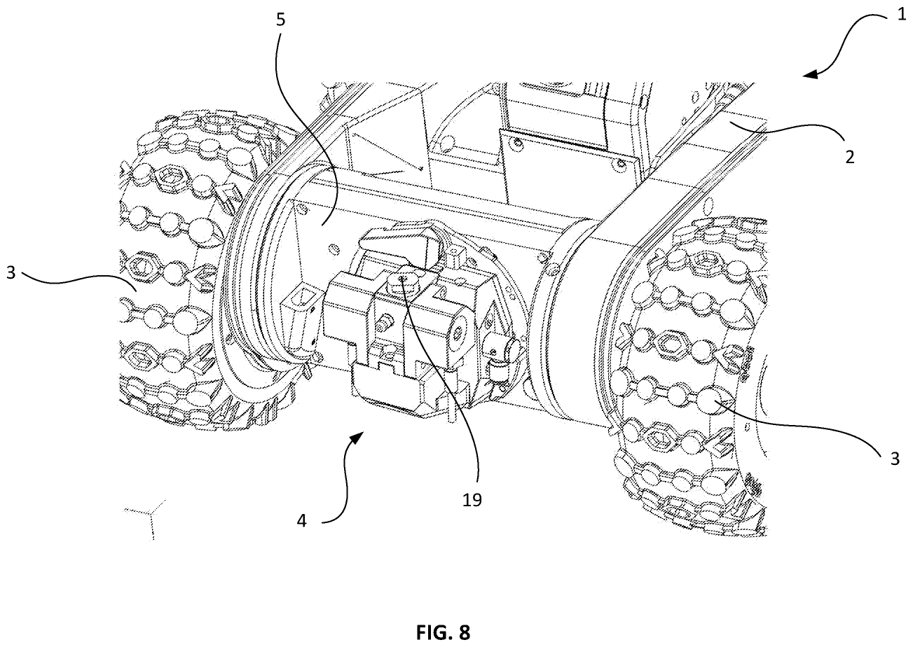

FIG. 8 shows the spray unit 4 mounted to the robotic device 1. As illustrated and briefly explained above, the spray unit 4 is mounted to a rotatable housing 5. The rotatable housing 5 is rotatable about an axis that is parallel to the rotational axes of the wheels 3. Rotation of the rotatable housing 5 thereby changes the angle of the spray unit 4, in particular the spray orifice 19, with respect to the robotic device 1 and also with respect to the surface to be sprayed.

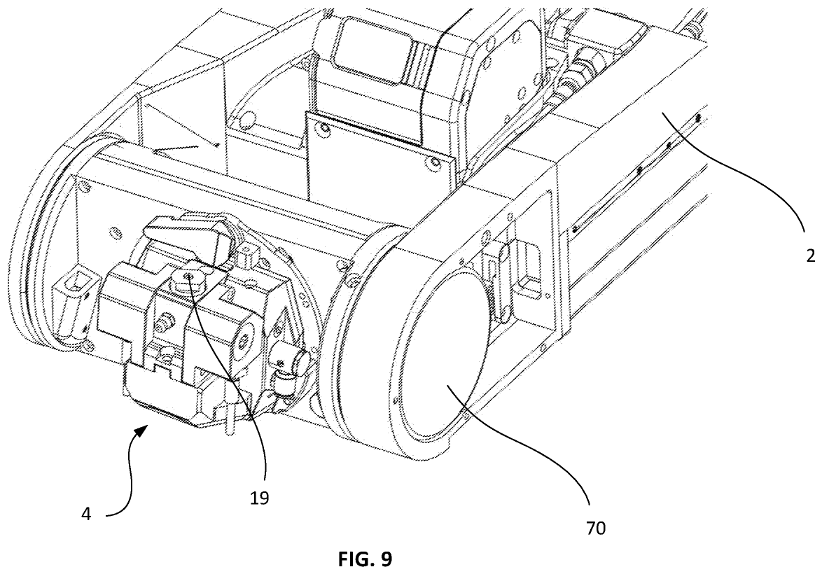

Rotation of the rotatable housing 5 is provided by motor 70 illustrated in FIG. 9. The motor 70 is mounted to the chassis 2 and coupled to the rotatable housing 5. The rotatable housing 5 is mounted to the chassis 2 on bearings to facilitate rotation. The motor 70 is controllable by the external control unit so that an operator can rotate the rotatable housing 5.

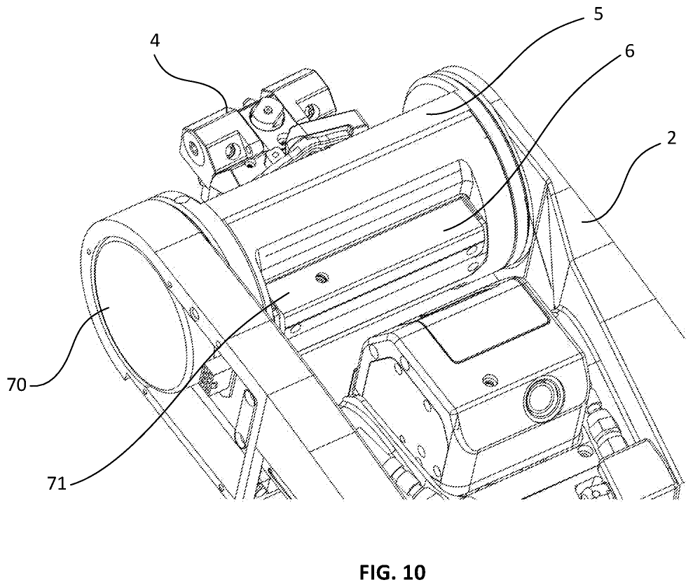

As shown in FIG. 10, a sensor is also mounted to the rotatable housing 5. In particular, a depth camera 6 is mounted to an opposite side of the rotatable housing 5 to the spray unit 4. The depth camera 6 is provided with a shutter 71 that covers the depth camera 6 when it is not being used to protect it from debris.

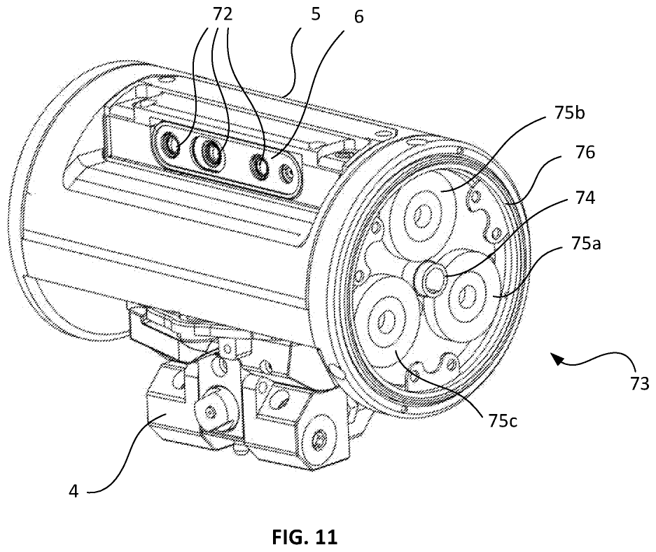

FIG. 11 shows the rotatable housing 5, including the spray unit 4 and the depth camera 6, without the shutter 71. As shown, the depth camera 6 includes one or more lenses 72 that are protected by the shutter.

The shutter is movable by a pneumatic actuator between a covering position shown in FIG. 10 and an open position in which the lenses 72 are exposed and can be used to detect a depth or distance.

As shown in FIG. 11, the rotatable housing 5 includes an epicyclic gear arrangement 73 for coupling the motor (70, see FIG. 9) to the rotatable housing 5. The central gear 74 is coupled to a shaft of the motor 70 and is engaged with intermediate gears 75a, 75b, 75c. Intermediate gears 75a, 75b, 75c are pivotally mounted to the chassis 2 so that their positions are fixed. Intermediate gears 75a, 75b, 75c engage ring gear 76, which is fixed to the rotatable housing 5. In this way, rotation of the central gear 74 by the motor 70 causes rotation of the ring gear 76 and the rotatable housing 5.

The rotational position of the rotatable housing 5 can be controlled from the external control unit via the hose 8, as shown in FIG. 4. The rotatable housing 5 may have set rotational positions, for example a first sensing position in which the depth camera 6 is directed forwards, a second sensing position in which the depth camera 6 is directed upwards, and a spraying position in which the spray orifice 19 of the spray unit 4 is directed upwards at an angle of 45 degrees. In some examples, the rotatable housing 5 may be rotated while spraying from the spray unit 4 to provide a spraying range of rotation. For example, the rotatable housing 5 may be rotated between a position in which the spray orifice 19 of the spray unit 4 is directed upwards at an angle of 45 degrees and a position in which the spray orifice 19 of the spray unit 4 is directed upwards at an angle of 90 degrees. Additionally or alternatively, the rotational position of the rotatable housing 5 may controlled by the operator.

The depth camera 6 may be used to look in front of the robotic device 1 to identify the positions of obstacles. Additionally or alternatively, the depth camera 6 may be used to measure a distance from the robotic device 1 to the surface to be sprayed, so that the robotic device 1 can be moved to within the range of the spray unit 4. Additionally or alternatively, the depth camera 6 may be used to check the thickness of the insulative covering after the thermally insulating material has been sprayed. In this example, the depth camera 6 may be used to take an initial reading of the distance from the robotic device 1 to the surface to be sprayed, and a subsequent reading of distance from the robotic device 1 to the surface of the insulative covering so that the control unit and/or operator can determine the thickness of the insulative covering. Such a measurement may be beneficial for accreditation of the insulative covering.

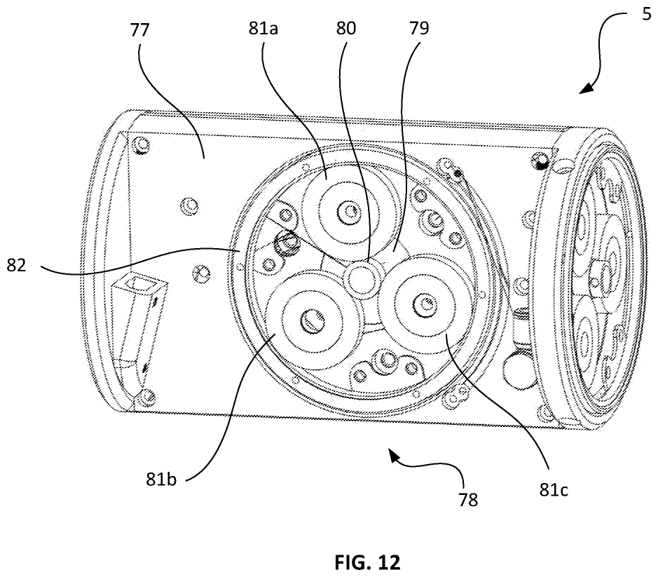

FIG. 12 shows the rotatable housing 5 with the spray unit 4 removed. As shown, the rotatable housing 5 includes a flat surface 77 to which the spray unit 4 is mounted. The spray unit 4 is rotatable with respect to the rotatable housing 5. The spray unit 4 can rotate about an axis that is perpendicular to the axis of rotation of the rotatable housing 5. In particular the spray unit 4 can rotate about an axis that is normal to the flat surface 77 of the rotatable housing 5.

As shown in FIG. 12, within the rotatable housing 5 there is a motor 79 and an epicyclic gear arrangement 78 for rotation of the spray unit 4. The motor 79 rotates motor gear 80, which engages intermediate gears 81a, 81b, 81c. Intermediate gears 81a, 81b, 81c are rotatably mounted to the rotatable housing 5 so that their positions are fixed. Intermediate gears 81a, 81b, 81c engage ring gear 82. In this way, ring gear 82 is rotated by the motor 79. The ring gear 82 may be mounted to the rotatable housing 5 by a bearing. Spray unit 4 is attachable to the ring gear 82 so that the motor 79 can rotate the spray unit 4.

In some examples, the epicyclic gear arrangements for rotating the rotatable housing (as shown in FIG. 11) and for rotating the spray unit 4 (as shown in FIG. 12) may be replaced by belt drive arrangements. In this case, the motors 70, 79 are offset from the rotational axes of the rotatable housing 5 and the spray unit 4, respectively, and a pulley-belt arrangement is provided for rotation of the rotatable housing 5 and the spray unit 4. Such a pulley-belt arrangement advantageously provides for routing connections, in particular pneumatic and electrical connections, from the chassis 2 to the rotatable housing 5 (and the sensor 6 and spray unit 4) through the axis of rotation of the rotatable housing 5. Additionally, pneumatic and electrical connections can be routed from the rotatable housing 5 to the spray unit 4 through the mounting plate 83. In this way, the electrical and pneumatic connections are protected and are not twisted on rotation of the rotatable housing 5 and/or spray unit 4. This is particularly advantageous in an underfloor cavity where they may be various obstacles on which hoses and cables could become tangled.

It will be appreciated that a combination of rotating the rotatable housing 5 and rotating the spray unit 4 provides for directing the spray orifice 19 of the spray unit 4 in any direction. Therefore, a wide area of a surface can be sprayed from a single position of the robotic device 1. Moving the robotic device 1 by the wheels 3 can further change what area of the surface can be sprayed, allowing the robotic device 1 to be used to spray an entire surface. In one mode of spraying, the spray unit 4 is rotated back and forth about an arc of rotation while the rotatable housing 5 is simultaneously rotated. In this way, the spray unit 4 sprays an area having a width determined by the length of the arc of rotation of the spray unit 4 and a length determined by the amount of rotation of the rotatable housing 5. The spray orifice 19 may be configured to spray the thermally insulating material in a cone, or in a flat plane.

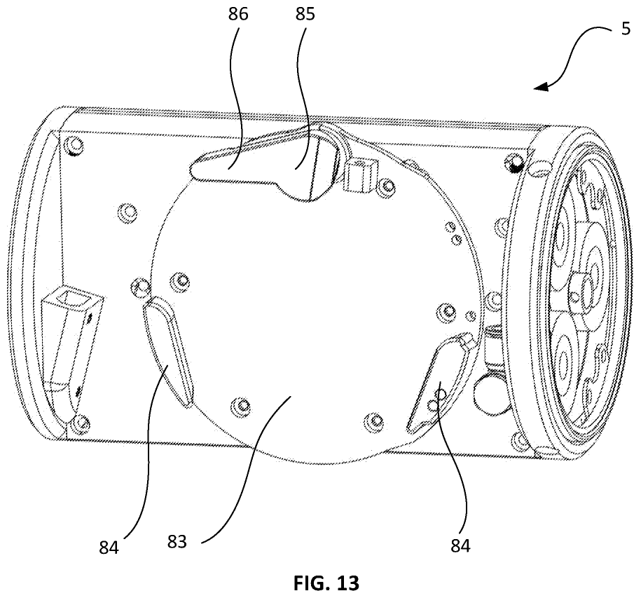

FIG. 13 illustrates a mounting plate 83 for removably attaching the spray unit 4 to the rotatable housing 5. In particular, the mounting plate 83 is fastened to the ring gear 82 shown in FIG. 12 so that the mounting plate 83 is rotated by motor 79.

The mounting plate 83 comprises guide blocks 84 that engage corresponding recesses or surfaces on the spray unit 4. In this way, the spray unit 4 can only be mounted to the mounting plate 83 in one orientation. A clamp 85 is arranged to clamp the spray unit 4 against the guide blocks 84 to secure the spray unit 4 to the mounting plate 83. The guide blocks 84 are angled to clamp the spray unit 4 towards the plate 83 and also to centralise the spray unit 4 on the mounting plate 83, so that the spray unit 4 always has the same relative position on the mounting plate 83 even after being removed and re-mounted. The clamp 85 has a handle 86 and is a quick-release type clamp, so that an operator can remove the spray unit 4 without the need for tools.

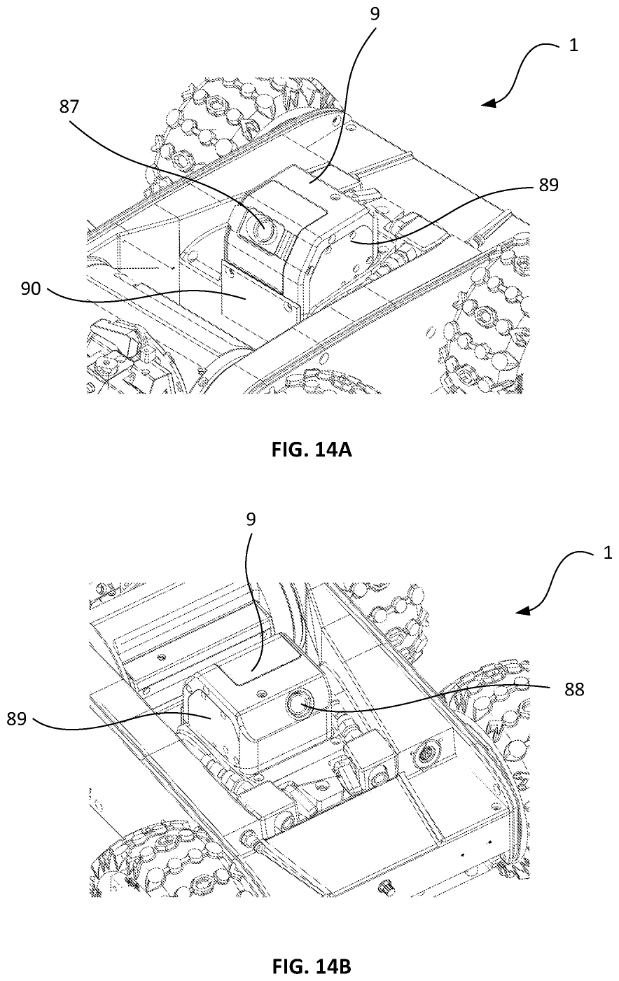

FIGS. 14A to 15 illustrate the camera assembly 9 of the robotic device 1. The camera assembly 9 includes a forward-facing camera 87 and a rearward-facing camera 88 arranged in a housing 89. The housing 89, together with the cameras 87, 88 are movable between the protruding position shown in FIGS. 14A and 14B and the retracted position shown in FIG. 15.

In the protruding position shown in FIGS. 14A and 14B the cameras 87, 88 are clear of the chassis 2 and surrounding components and can view the underside 12 of the floor 13 as shown in FIG. 4. In the retracted position shown in FIG. 15, due to the angled arrangement of the cameras 87, 88 they can still view the underside 12 of the floor 13, but the view may be restricted. Advantageously, in the retracted position the overall height of the robotic device 1 is reduced, allowing the robotic device 1 to fit in a smaller cavity and/or pass underneath overhead objects such as the joist 14 illustrated in FIG. 4.

As shown in FIG. 15, in the retracted position the forward-facing camera 87 is positioned above the corresponding part of the chassis 2. In particular, the chassis 2 includes a window defined by the edge of plate 90 so that in the retracted position the chassis 2 does not obstruct the view of the forward-facing camera 87.

The forward-facing camera 87 is angled at approximately 45 degrees to a longitudinal direction of the robotic device 1 so that it views the underside 12 of the floor 13 in front of the robotic device 1, as shown in FIG. 4. Similarly, the rearward-facing camera 88 is angled at approximately 45 degrees to a longitudinal direction of the robotic device 1 so that it views the underside 12 of the floor 1 behind the robotic device 1, as shown in FIG. 4.

The cameras 87, 88 preferably provide a video feed to the remote operator at the external control unit showing the underside 12 of the floor 13. In this way, the operator can see the surface to be sprayed, can identify obstacles, and can inspect the insulative covering after spraying.

The cameras 87, 88 are preferably video cameras. The cameras 87, 88 may additionally or alternatively include a thermal imaging sensor, a rangefinder sensor, for example a laser rangefinder sensor, or other sensor.

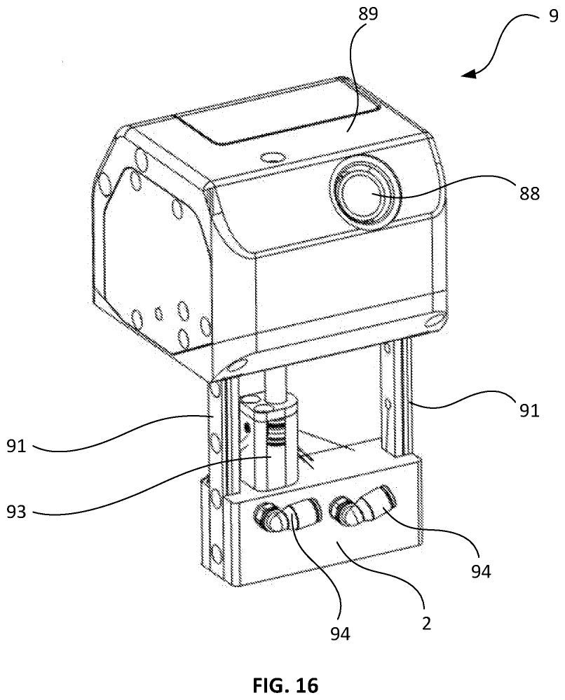

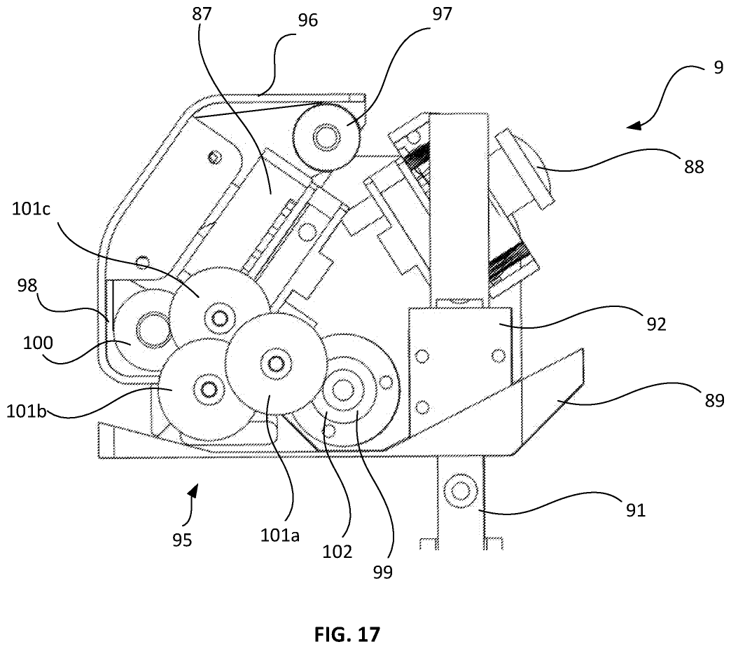

As shown in FIG. 16, the housing 89, together with the cameras 87, 88, is mounted to guide rails 91 that are fixed to a part of the chassis 2. The housing 89 may be mounted to the guide rails 91 via linear bearings (92, see FIG. 17) for smooth movement of the housing 89 along the guide rails 91 between the protruding and retracted positions.

A pneumatic actuator 93 is provided to move the housing 89 along the guide rails 91, between the protruding and retracted positions. The pneumatic actuator 93 is supplied with compressed air via ports 94, and the supply of compressed air to the ports 94 is controlled by a remotely operated control valve controlled from the exterior control unit via the hose 8 shown in FIG. 4. In this way, the operator can move the camera assembly 9 between the protruding and retracted positions.

FIG. 17 illustrates a side view of the camera assembly 9 with one part of the housing 89 removed from view. The linear bearings 92 and guide rail 91 for movement of the camera assembly 9 between the protruding and retracted positions are illustrated.

FIG. 17 also illustrates a protective film assembly 95 of the camera assembly 9. The protective film assembly 95 includes a protective film 96 that is positioned in front of a lens of the front-facing camera 87 to protect the camera 87 from debris, in particular the sprayed thermally insulating material. The protective film 96 is preferably transparent.

The protective film 96 is provided on an input spool 97 and is wound onto output spool 98 during operation. The output spool 98 is driven by a motor 99 via gear assembly. The output spool 98 draws the protective film 96 from the input spool 97 so that it passes over the lens of the camera 87 in a sensing direction of the camera 87. The output spool 98 may be driven continuously, or the output spool 98 may be driven occasionally when the view of the camera 87 is obscured by accrual of debris on the protective film. Rotation of the output spool 98 may be controlled manually when an operator deems it necessary based on an obscured view from the camera 87, or it may be driven periodically at a fixed time interval, or it may be driven automatically in response to detecting an obscured view through the camera 87.

The motor 99 is rotationally coupled to a gear 100 on the output spool 98 for rotation of the output spool 98. The gear assembly is provided between a motor gear 102 and the gear 100 of the output spool 98 to provide appropriate gearing for the operational speed of the motor 99.

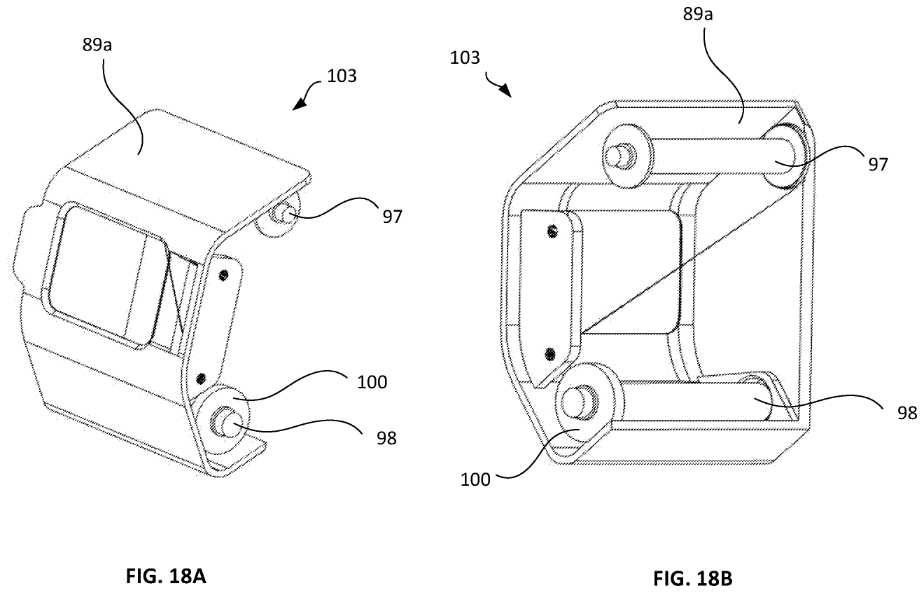

FIGS. 18A and 18B show a removable cartridge 103 of the camera assembly 9, in particular of the protective film assembly 95. As shown, the removable cartridge 103 includes a portion 89a of the housing 89, the input spool 97, the output spool 98, and the gear 100 on the output spool 98. The removable cartridge 103 is removably attached to the rest of the camera assembly 9 by a fastener. On removal of the removable cartridge 103 from the camera assembly 9, the gear 100 on the output spool 98 disengages from the intermediate gear 101c shown in FIG. 17.

Once the removable cartridge 103 has been removed from the camera assembly 9 the output spool 98 can be emptied and the input spool 97 can be replaced.

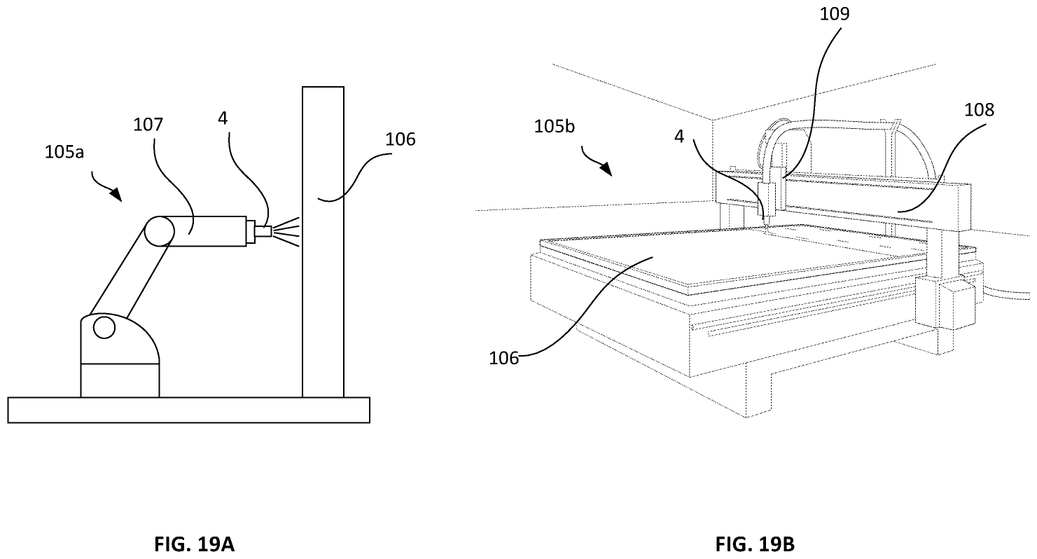

FIGS. 19A and 19B illustrate further example robotic devices 105a, 105b that include the spray unit 4 described with reference to FIGS. 5A to 7B. The robotic devices 105a, 105b are operable to spray a thermally insulating material onto a surface of a building element 106, for example a wall or a façade.

As shown in FIG. 19A, the robotic device 105a includes an articulated arm 107 on which the spray unit 4 is mounted. The articulated arm 107 is operable to move the spray unit 4 relative to the building element 106 so that the spray unit 4 can spray a thermally insulating material onto the building element 106. The articulated arm 107 and the spray unit 4 can be controlled by an external control unit for remote and/or automated operation of the robotic device 105a.

In the example, of FIG. 19B, the robotic device 105b includes a frame, for example a gantry 108, having a movable part 109 to which the spray unit 4 is attached. The gantry 108 is operable to move the spray unit 4 over a surface of a building element 106 to spray thermally insulating material thereto. The gantry 108 is operable to move the spray unit 4 in two directions so that the spray unit 4 can be moved over a horizontal surface, as illustrated. The gantry 108 may also be operable to move the spray unit 4 in a third direction to change a distance between the spray unit 4 and the building element 106. In the example of FIG. 19B the robotic device 105b is arranged to spray thermally insulating material onto a horizontal surface, with the building element 106 arranged on a bed. However, it will be appreciated that the robotic device 105b, in particular the gantry 108, may alternatively be arranged to direct the spray unit 4 towards a vertical or inclined surface. The robotic device 105b, in particular the gantry 108 and the spray unit 4, can be controlled by an external control unit for remote and/or automated operation of the robotic device 105a.

In some examples, the robotic device 105a, 105b is operable in an off-site location, to manufacture a building element 106 that can later be mounted to a building or assembled with other building elements to form a building or a part of a building. In other examples, the robotic device 105a, 105b is operable on-site and configured to apply a thermally insulating material to a building element in-situ, such as a wall or façade of a building.

In the examples of FIGS. 19A and 19B the robotic device 105a, 105b may include a sensor, for example a depth sensor and/or a camera to detect the building element 106 and/or the thermally insulating material applied to the building element 106.

In summary, there is provided a spray unit for a remotely operable spray apparatus. The spray unit is configured to spray a material having first and second material components. The spray unit comprises a first material inlet for receiving the first material component and a second material inlet for receiving the second material component. The spray unit also has a spray component comprising a mixing chamber and a spray orifice. The spray component is movable between a spraying position in which the mixing chamber is in communication with the first and second material inlets such that the first and second material components enter the mixing chamber and are sprayed via the spray orifice, and a non-spraying position in which the mixing chamber is closed from the first and second material inlets. The spray unit also includes a pneumatic actuator operable to move the spray component between the spraying position and the non-spraying position, and a remotely operable electric actuator arranged to control operation of the pneumatic actuator.

Therefore, the spray unit can be remotely controlled to spray an insulation material, for example from an external control unit. The spray unit is particularly adapted for use spraying thermal insulation material in confined spaces, for example under a floor of a building. The spray unit can be mounted to a robotic device, for example a robotic vehicle, for moving the spray unit through the confined space.

There is also provided a robotic device for spraying a thermally insulating material onto an underside of a floor from within an underfloor cavity of a building. The robotic device includes a chassis and a rotatable housing mounted to the chassis for rotation about a housing axis. A spray unit is mounted to the rotatable housing, and the spray unit is configured to spray the thermally insulating material in a spraying direction. A sensor is also mounted to the rotatable housing, and the sensor is directed in a sensing direction. The spray unit and the sensor are mounted to the rotatable housing so that the spraying direction is offset from the sensing direction in the direction of rotation of the rotatable housing.

In this way, the rotatable housing can be rotated to direct either the spray unit or the sensor towards the underside of the floor, so that the sensor can detect the underside of the floor and the spray unit can spray thermally insulating material onto the underside of the floor. Mounting both of the spray unit and the sensor to the rotatable housing provides a compact robotic device and also protects the sensor from spray debris while operating the spray unit.

There is also provided a robotic device for operating in an underfloor cavity below a floor of a building. The robotic device has a sensor assembly that includes a housing and at least one sensor mounted to the housing. The housing is movable between an extended position in which the sensor assembly protrudes from robotic device, and a retracted position in which the sensor assembly does not protrude from the robotic device. At least one sensor of the sensor assembly is arranged such that in both the extended position and the retracted position the sensor has a field of view encompassing a part of the underfloor cavity, in particular a part of an underside of the floor.

In this way, the housing can be retracted if the underfloor cavity is small relative to the robotic device, or if the robotic device has to avoid obstacles. However, even in the retracted position the sensor can view a part of the underside of the floor so can still be used to provide information for controlling the robotic device.

There is also provided a sensor unit comprising a housing, a sensor mounted in the housing and directed in a sensing direction, and a protective film assembly arranged to protect the sensor from debris. The protective film assembly has a spool mount for a spool of transparent film, a winding mount comprising a winding spool and an actuator arranged to wind the transparent film onto the winding spool, and a guide arranged to guide the transparent film past the sensor such that the transparent film is disposed in the sensing direction of the sensor. The transparent film thereby protects the sensor from debris. The spool mount and the winding mount are removable from the protective film assembly for replacing the spool of transparent film.

In this way, the spool mount and the winding mount can be removed from the sensor unit for replacing the transparent film once the spool of transparent film has been exhausted.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A spray unit for a remotely operable spray apparatus, the spray unit being configured to spray a material having first and second material components, the spray unit comprising:
a first material inlet for receiving the first material component;
a second material inlet for receiving the second material component;
a spray component including a mixing chamber and a spray orifice, the spray component being movable between:
a spraying position, wherein the mixing chamber is in communication with the first and second material inlets such that the first and second material components enter the mixing chamber and can be sprayed via the spray orifice; and
a non-spraying position, wherein the mixing chamber is closed from the first and second material inlets;
a pneumatic actuator operable to move the spray component between the spraying position and the non-spraying position; and
a remotely operable electric actuator adapted to control operation of the pneumatic actuator.

2. The spray unit as claimed in claim 1, further comprising a pneumatic control mechanism configured to supply compressed air to the pneumatic actuator to control operation of the pneumatic actuator, the pneumatic control mechanism including the remotely operable electric actuator.

3. The spray unit as claimed in claim 2, wherein the pneumatic control mechanism includes:
a control component disposed in a control chamber,
first and second pneumatic channels connecting the control chamber to opposing sides of the pneumatic actuator; and
a compressed air inlet providing compressed air to the control chamber;
wherein the control component is movable between:
a first position, wherein the compressed air inlet is in fluid communication with the first pneumatic channel and the compressed air inlet is closed from the second pneumatic channel to move the spray component to the spraying position, and
a second position, wherein the compressed air inlet is in fluid communication with the second pneumatic channel and the compressed air inlet is closed from the first pneumatic channel to move the spray component to the non-spraying position.

4. The spray unit as claimed in claim 3, wherein the control chamber further includes first and second exhaust outlets, and wherein in the first position of the control component the second pneumatic channel is connected to the first exhaust outlet, and in the second position of the control component the first pneumatic channel is connected to the second exhaust outlet.

5. The spray unit as claimed in claim 3, wherein the position of the control component in the control chamber is controlled by a pneumatic mechanism, and wherein the remotely operable electric actuator is configured to control the pneumatic mechanism to move the control component between the first position and the second position.

6. The spray unit as claimed in claim 5, wherein a first end of the control chamber includes a first inlet, and a second end of the control chamber includes a second inlet, wherein the pneumatic control mechanism includes fluid channels that connect the compressed air inlet to the first inlet and the second inlet, and wherein the remotely operable electric actuator is operable to open or close at least one of the fluid channels to direct compressed air from the compressed air inlet to the first inlet and/or the second inlet to control movement of the control component between the first position and the second position.

7. The spray unit as claimed in claim 6, wherein the remotely operable electric actuator includes a linear actuator movable between an extended position and a retracted position, and wherein in at least one of the extended position or the retracted position at least one of the fluid channels is blocked.

8. The spray unit as claimed in claim 6, wherein the remotely operable electric actuator is configured to direct compressed air to either:
the first inlet of the control chamber; or
the first inlet and the second inlet of the control chamber;
and wherein the surface area of the control component at the second end of the control chamber is greater than the surface area of the control component at the first end of the control chamber.

9. The spray unit as claimed in claim 6, further comprising a spring disposed at the first end of the control chamber and arranged to urge the control component towards the second end of the control chamber.

10. The spray unit as claimed in claim 3, wherein the spray component, pneumatic actuator, pneumatic control mechanism, and the remotely operable electric actuator are disposed in a housing of the spray unit.

11. The spray unit as claimed in claim 10, wherein the remotely operable electric actuator is a linear actuator and wherein the direction of movement of the remotely operable electric actuator is offset from the direction of movement of the control component of the pneumatic control mechanism.

12. The spray unit as claimed in claim 1, where the remotely operable electric actuator is configured to be operated from an external control unit.

13. The spray unit as claimed in claim 1, wherein the spray component includes a piston, the piston forming a part of the pneumatic actuator.

14. The spray unit as claimed in claim 1, wherein the spray unit includes a single compressed air inlet for receiving a supply of compressed air, and wherein a housing of the spray unit comprises a plurality of pneumatic channels arranged to direct the compressed air.

15. The spray unit as claimed in claim 14, further comprising an air purge opening that is in fluid communication with the mixing chamber and the spray orifice when the spray component is in the non-spraying position, and an air purge channel connecting the compressed air inlet to the air purge opening.

16. A robotic device for spraying a thermally insulating material onto an underside of a floor from within an underfloor cavity of a building, the robotic device comprising:
a chassis;
a rotatable housing mounted to the chassis for rotation about a housing axis;
a spray unit mounted to the rotatable housing, the spray unit being configured to spray the thermally insulating material in a spraying direction; and
a sensor mounted to the rotatable housing, the sensor being directed in a sensing direction;
wherein the spray unit and the sensor are mounted to the rotatable housing so that the spraying direction is offset from the sensing direction in the direction of rotation of the rotatable housing.

17. The robotic device as claimed in claim 16, wherein the spray unit is configured to spray the thermally insulating material while the rotatable housing rotates to vary the spraying direction.

18. The robotic device as claimed in claim 16, wherein the spray unit is rotatably mounted to the rotatable housing about a spray unit axis, the spray unit axis being perpendicular to the housing axis.

19. The robotic device as claimed in claim 18, further comprising an actuator arranged to rotate the spray unit about the spray unit axis.

20. The robotic device as claimed in claim 18, wherein the spray unit is configured to be rotated about the spray unit axis of rotation during spraying of the thermally insulating material to vary the spraying direction.

21. The robotic device as claimed in claim 16, wherein the sensor comprises a depth sensor.

22. The robotic device as claimed in claim 16, wherein the spray unit is detachable from the rotatable housing.

23. The robotic device as claimed in claim 16, further comprising a motor and a pulley-belt assembly configured to couple the rotatable housing to the motor such that the motor is operable to rotate the rotatable housing, and wherein a connection for the spray unit is routed from the chassis to the spray unit through an opening in the pulley.

24. A robotic device for operating in an underfloor cavity below a floor of a building, the robotic device comprising
a sensor assembly having a housing and at least one sensor mounted to the housing;
wherein the housing is movable between an extended position in which the sensor assembly protrudes from robotic device, and a retracted position in which the sensor assembly does not protrude from the robotic device;
and wherein the at least one sensor of the sensor assembly is arranged such that in both the extended position and the retracted position the sensor has a field of view encompassing a part of the underfloor cavity, in particular a part of an underside of the floor.

25. A sensor unit comprising a housing, a sensor mounted in the housing and directed in a sensing direction, and a protective film assembly arranged to protect the sensor from debris;
wherein the protective film assembly comprises a spool mount for a spool of transparent film, a winding mount comprising a winding spool and an actuator arranged to wind the transparent film onto the winding spool, and a guide arranged to guide the transparent film past the sensor such that the transparent film is disposed in the sensing direction of the sensor;
and wherein the spool mount and the winding mount are removable from the protective film assembly for replacing the spool of transparent film.
